(19) United States
(12) Patent Application Publication
(10) Pub. No.: US 2021/0329904 A1
(43) Pub. Date: Oct. 28, 2021

(54) MOSQUITO-KILLING LAMP

(71) Applicant: ZHEJIANG SORBO TECHNOLOGY CO.,LTD., Wenzhou (CN)

(72) Inventors: Xuyu Li, Wenzhou (CN); Qingbao Lin, Wenzhou (CN); Chaogui Li, Wenzhou (CN); Xinxin Zheng, Wenzhou (CN); Zhanyou Zhang, Wenzhou (CN)

(73) Assignee: ZHEJIANG SORBO TECHNOLOGY CO.,LTD.

(21) Appl. No.: 17/349,950

(22) Filed: Jun. 17, 2021

(30) Foreign Application Priority Data
Feb. 4, 2021 (CN) 202110154144.2

(51) Int. Cl. A01M 1/08

(52) U.S. Cl. CPC A01M 1/08; A01M 2200/012

(57) ABSTRACT

The present disclosure relates to a mosquito-killing lamp, including a shell. The shell is provided with a fan, an air inlet, an air outlet, a manual operation open-close mechanism, and an installation cavity and a mosquito storage cavity that are cut through. The air inlet, the installation cavity, the mosquito storage cavity, and the air outlet constitute an air duct; mosquitoes enter the mosquito storage cavity from the air inlet when the manual operation open-close mechanism is in opened state, and mosquitoes are prevented from flying from the mosquito storage cavity to the installation cavity when the manual operation open-close mechanism is in the closed state. The present disclosure has the advantages that mosquitoes fly out hardly, and the mosquito-killing effect is better.

### TECHNICAL FIELD

The present disclosure relates to the technical field of mosquito-killing equipment, in particular, a mosquito-killing lamp.

### BACKGROUND

There are often various kinds of mosquitoes in public places or at home. Mosquitoes can affect people's normal rest and carry germs. Therefore, mosquitoes need to be killed.

A general mosquito-killing lamp includes a shell. The shell includes an upper shell, a fan frame, and a lower shell that are sequentially arranged from top to bottom. The upper shell and the lower shell are connected through the fan frame, and the upper shell is provided with a mosquito inlet cavity. The lower shell is provided with a mosquito storage cavity; the fan frame is internally provided with an installation cavity for communicating the mosquito inlet cavity with the mosquito storage cavity; the installation cavity is equipped with a fan; the upper shell is provided with an air inlet for mosquitoes to fly into the installation cavity; and the lower shell is provided with an air outlet communicating with the mosquito storage cavity. The air inlet, the mosquito inlet cavity, the installation cavity, the mosquito storage cavity, and the air outlet constitute an air duct. A mosquito-lured lamp is also arranged in the shell. When the fan works, negative pressure is generated at the air outlet, and mosquitoes fly to the air inlet and are sucked into the mosquito inlet cavity and then brought to the mosquito storage cavity by air flow. However, in this type of mosquito-killing lamp, the mosquitoes will fly out from the air inlet of the upper shell due to an open upper port of the mosquito storage cavity when the fan stops working, and the mosquito-killing effect is poor.

### SUMMARY

The present disclosure overcomes the shortcomings in the existing technology, and provides a mosquito-killing lamp which has a mosquito-killing function, causes mosquitoes to be difficult to fly out, and is better in mosquito-killing effect.

In order to achieve the above-mentioned purpose, the technical solution used by the present disclosure is a mosquito-killing lamp, including a shell. The shell is provided with an installation cavity and a mosquito storage cavity; the installation cavity and the mosquito storage cavity are cut through; the shell is equipped with a fan inside the installation cavity; the shell is provided with an air inlet for mosquitoes to fly into the installation cavity; the shell is provided with an air outlet communicating with the mosquito storage cavity; the air inlet, the installation cavity, the mosquito storage cavity, and the air outlet constitute an air duct; the shell is provided with a manual operation open-close mechanism located between the installation cavity and the installation cavity; the manual operation open-close mechanism has a first position for an opened state and a second position for a closed state; mosquitoes can enter the mosquito storage cavity from the air inlet when the manual operation open-close mechanism is at the first position for the opened state, and mosquitoes can be prevented from flying from the mosquito storage cavity to the installation cavity when the manual operation open-close mechanism is at the second position for the closed state. The manual operation open-close mechanism includes a toggle or a knob and a blade. The toggle or knob is operated to drive the blade to move; and the blade moves to realize the first position for the opened state and the second position for the closed state.

By the adoption of the above solution, the shell is fixed or integrally provided with a fan frame in the installation cavity, and the fan is fixedly arranged on the fan frame. The fan is a conventional technology in the art, so it is not specifically introduced in this article. The blade can be manually driven to move by the toggle or knob. The blade moves to the first position for the opened state, which can mean partially opened or fully opened, as long as mosquitoes can enter the mosquito storage cavity from the air inlet. The blade moves to the second position for the closed state, which can mean partially closed or fully closed, as long as mosquitoes cannot fly out of the mosquito storage cavity. When mosquito killing is needed, the blade is manually driven to move to the first position for the opened state; the fan is energized, which can drive air in the shell to flow, and the air can enter the installation cavity from the air inlet, then pass through the mosquito storage cavity, and finally flow out from the air outlet; the mosquitoes that fly to the air inlet may be sucked into the installation cavity and then carried by the air flow to the mosquito storage cavity. The mosquitoes cannot fly out of the air outlet. As long as the fan keeps working, the mosquitoes will remain in the mosquito storage cavity under the driving of the air flow. When mosquito killing is not needed, the blade is manually driven to move to the second position for the closed state, the fan stops working, and the mosquitoes are kept in the mosquito storage cavity until the mosquitoes die. It is hard for the mosquitoes to fly out, and the mosquito-killing effect is better.

In a further setting of the present disclosure, the shell is provided with a mosquito-retaining seat located between the installation cavity and the mosquito storage cavity. The mosquito-retaining seat is provided with a first through hole that communicates the installation cavity with the mosquito storage cavity. The blade is rotatably arranged on the mosquito-retaining seat; an end surface of the blade is adhered to or close to an end surface of the mosquito-retaining seat. The toggle or knob is operated to drive the blade to rotate. When the blade rotates to close the first through hole, the mosquitoes can be prevented from flying into the installation cavity from the mosquito storage cavity. When the blade rotates to open the first through hole, the mosquitoes can enter the mosquito storage cavity from the air inlet.

By the adoption of the above-mentioned solution, the mosquito-retaining seat can be integrally or separately arranged on the shell. The blade opening the first through hole can be partially opened or fully opened, as long as mosquitoes can fly through the first through hole and enter the mosquito storage cavity. The blade closing the first through hole can be partially closed or fully closed, as long as mosquitoes cannot fly through.

In a further setting of the present disclosure, the blade is provided with a second through hole adapting to the shape of the first through hole. The blade rotates to realize mutual communication or misalignment between the second through hole and the first through hole.

By the adoption of the above solution, the first through hole and the second through hole can be partially or fully communicating, as long as the mosquitoes can fly through. The first through hole and the second through hole can be partially misaligned or fully misaligned, as long as the mosquitoes cannot fly over. When mosquito killing is needed, the blade is rotated to drive the first through hole and the second through hole to communicate with each other; and when mosquito killing is not needed, the blade is rotated to drive the first through hole and the second through hole to be misaligned with each other. The numbers and positions of the first through hole and the second through hole can be designed according to an actual need.

In a further setting of the present disclosure, the shell is provided with a microswitch close to the blade. When the blade rotates to a position where the second through hole and the first through hole communicate with each other, the blade can trigger a contact of the microswitch.

By the adoption of the above solution, the microswitch can open or close an entire mosquito-killing circuit. When the blade rotates to the position where the second through hole and the first through hole communicate with each other, the through holes can be fully communicating or partially communicating. In the fully communicating state, a passage for the mosquitoes to fly in is maximum, the blade triggers the microswitch, and the microswitch switches on the mosquito-killing circuit; at this time, the mosquito-killing lamp and the fan can be turned on; and the mosquito-killing lamp can be better controlled by means of mutual cooperation between a mechanical switch and an electronic switch.

In a further setting of the present disclosure, the blade is of a disk shape. The blade is arranged above the mosquito-retaining seat; the middle of the mosquito-retaining seat extends upwards to form a rotating shaft; the blade is rotatably arranged on the rotating shaft; the mosquito-retaining seat is provided with a limiting structure for limiting the rotation of the blade; the blade is fixedly or integrally provided with a toggle; and the toggle extends out of the shell.

By the adoption of the above solution, the position of the blade is reasonably designed. Compared with a solution that the blade is arranged below the mosquito-retaining seat, this solution can eliminate a positioning structure. The limiting structure can limit a rotation angle of the blade. The toggle extends out of the shell, so that a finger can drive the toggle to move to drive the blade to rotate to perform manual control; and moreover, there is a relatively low requirement for the rotation angle of the blade, so that the blade does not need to rotate a relatively angle for adjustment. The structure is simple, and the operation is convenient.

In a further setting of the present disclosure, the shell includes an upper shell and a lower shell. The upper shell and the lower shell are connected; the installation cavity is arranged on the upper shell, and the mosquito storage cavity is arranged on the lower shell; the mosquito-retaining seat is clamped between the upper shell and the lower shell; and the mosquito-retaining seat and the lower shell are in plugging fit.

By the adoption of the above solution, the upper shell and the lower shell can be fixedly connected or detachably connected, as long as they can be separated to clear mosquitoes. When the upper shell and the lower shell are separated, the mosquito-retaining seat can also stop the mosquitoes and prevent the mosquitoes from flying out of the mosquito storage cavity; furthermore, the mosquito-retaining seat and the lower shell are in plugging fit to facilitate removal of the mosquito-retaining seat and clearing of the mosquito storage cavity. The structure is simple, and the design is reasonable.

In a further setting of the present disclosure, the limiting structure is a first limiting seat and a second limiting seat that are fixedly or integrally provided on the mosquito-retaining seat. The first limiting seat and the second limiting seat are respectively located on two sides of the toggle. The toggle presses against the first limiting seat and the second limiting seat to realize rotation limitation to the blade.

By the adoption of the above solution, the first limiting seat and the second limiting seat can limit the rotation angle of the toggle to limit the rotation angle of the blade. The structure is simple, and the design is reasonable.

In a further setting of the present disclosure, the blade is provided with a press block; the microswitch is mounted at the lower end of the upper shell; and the press block of the blade can trigger the contact of the microswitch.

By the adoption of the above solution, the lower end of the upper shell is provided with a placement cavity for installing the microswitch; and the press block of the blade can trigger the microswitch. The structure is simple, and the design is reasonable.

In a further setting of the present disclosure, the upper shell includes a middle frame and an upper cover; the upper cover covers the middle frame and is connected with the middle frame; the middle frame is connected with the lower shell; the air inlet is formed in the upper cover; the installation cavity is disposed in the middle frame; the upper cover is provided with a mosquito-lured lamp; the upper cover is provided with a lampshade covering the mosquito-lured lamp; a protective sleeve is clamped between the middle frame and the upper cover; and the protective sleeve is provided with a through port for mosquitoes to fly into the installation cavity.

By the adoption of the above solution, the protective sleeve and the upper cover are fixedly connected by screws; the lampshade is clamped between the upper cover and the protective sleeve; the protective sleeve and the middle frame are connected by a snap-in manner; the middle frame and the lower shell are screwed by means of a stop block and a stop slot to restrain their separation and also realize their connection, and this is also convenient for disassembling, assembling and cleaning. Since the air inlet of the upper cover is relatively large, the protective sleeve is provided, which will not affect passing of the mosquitoes and can prevent sundries from falling into the mosquito inlet cavity to damage the fan and also prevent a hand from extending into the mosquito inlet cavity by mistake. It is safer. The mosquito-lured lamp can attract and lure mosquitoes to get close to the air inlet, making the mosquito-killing effect better.

In a further setting of the present disclosure, the air outlet includes a first air outlet formed in a side wall of the lower shell and a second air outlet formed in a bottom surface of the lower shell. The lower shell is provided with an anti-mosquito net located at the second air outlet.

By the adoption of the above solution, the second air outlet is relatively large. By the arrangement of the anti-mosquito net, mosquitoes can be prevented from flying out from the second air outlet of the lower shell. The first air outlet is relatively small, so that it is hard for mosquitoes to fly out. The arrangement of the first air outlet and the second air outlet can increase air circulation. The structure is simple, and the design is reasonable.

The present disclosure is further described below in combination with accompanying drawings.

### BRIEF DESCRIPTION OF THE DRAWINGS

FIG. 1 is an overall schematic structural diagram of an embodiment of the present disclosure;

FIG. 2 is a schematic structural diagram of installation of a mosquito-retaining seat;

FIG. 3 is a schematic diagram of a mutual communication state of a first through hole and a second through hole;

FIG. 4 is a schematic diagram of a mutual misalignment state of a first through hole and a second through hole;

FIG. 5 is a schematic structural diagram of installation of a microswitch;

FIG. 6 is a schematic structural diagram of a mosquito-retaining seat;

FIG. 7 is a schematic structural diagram of a blade;

FIG. 8 is a schematic structural diagram of installation of a fan;

FIG. 9 is a schematic structural diagram of installation of an anti-mosquito net;

FIG. 10 is a schematic structural diagram of a lower shell;

FIG. 11 is a schematic structural diagram of cooperation of an upper cover, a lampshade and a protective sleeve;

FIG. 12 is a schematic structural diagram of cooperation of a mosquito-lured lamp and an upper cover;

FIG. 13 is a schematic structural diagram of a lampshade; and

FIG. 14 is a schematic structural diagram of a protective sleeve.

### DESCRIPTION OF THE EMBODIMENTS

In the description of the present disclosure, it should be understood that orientations or positional relationships indicated by the terms “upper”, “lower”, “front”, “rear”, “left”, “right”, “top”, “bottom”, “inside”, “outside” and the like are orientations or positional relationships as shown in the drawings, and are only for the purpose of facilitating and simplifying the description of the present disclosure instead of indicating or implying that devices or elements indicated must have particular orientations, and be constructed and operated in the particular orientations, so that these terms are construed as limiting the present disclosure.

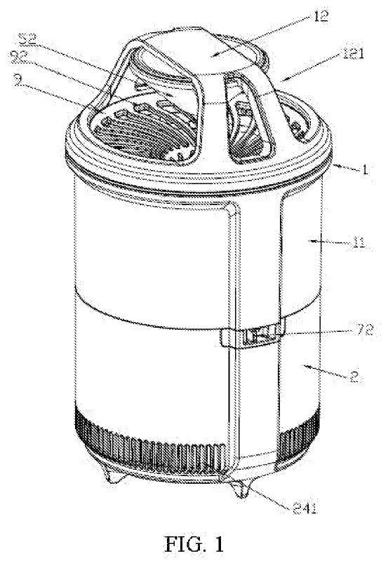

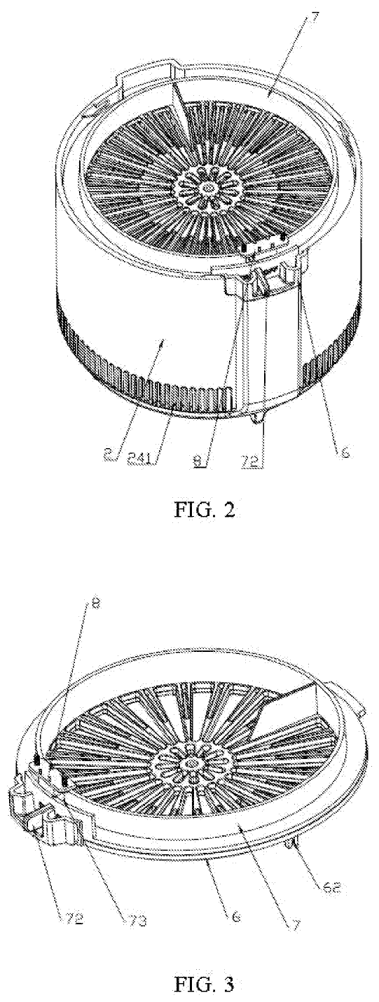

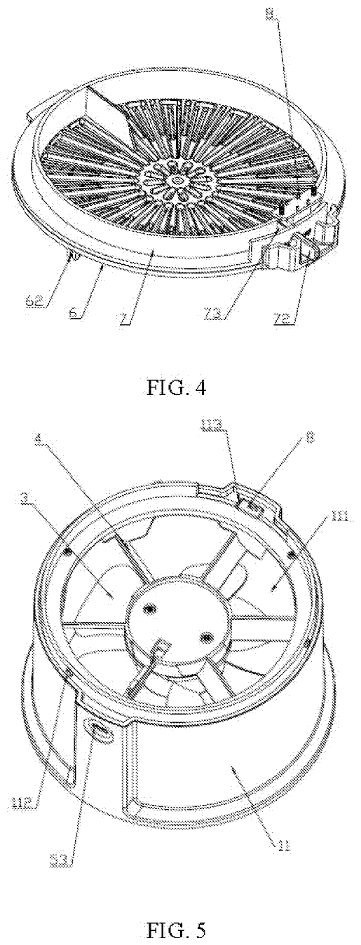

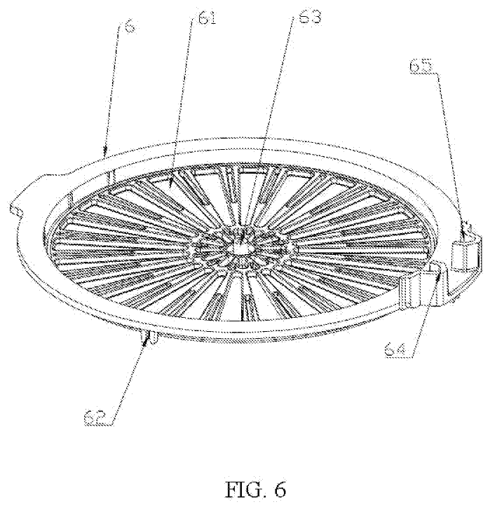

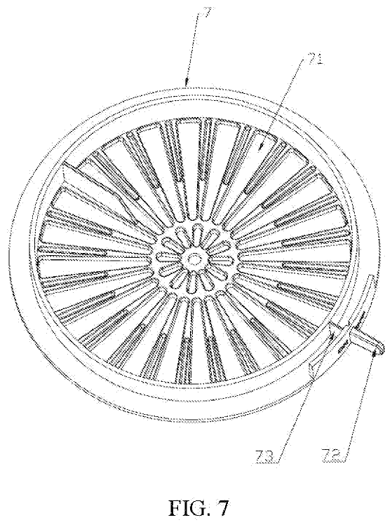

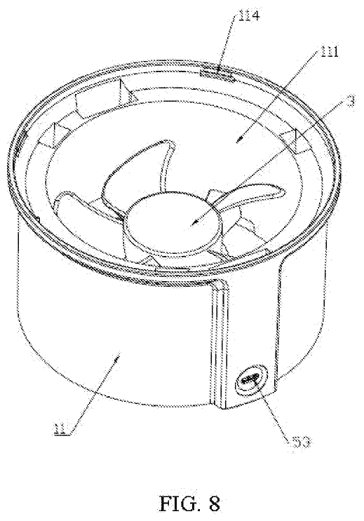

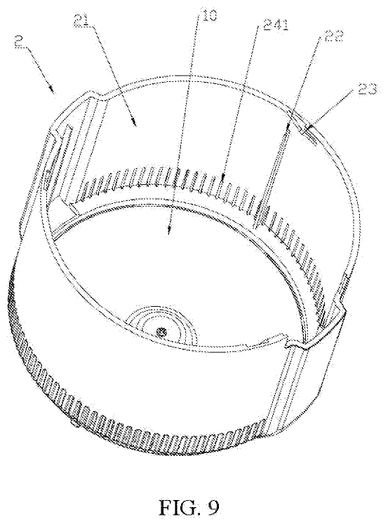

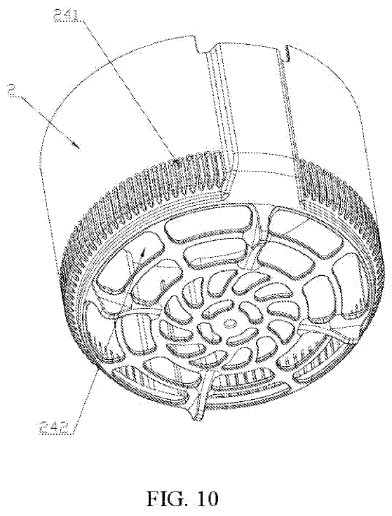

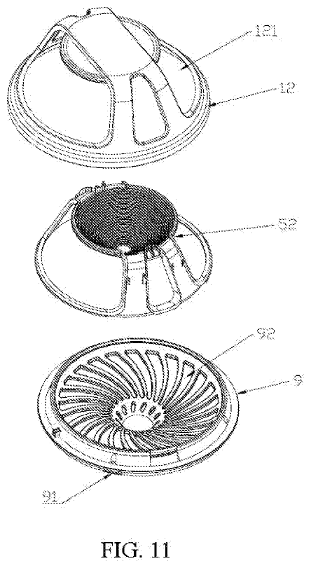

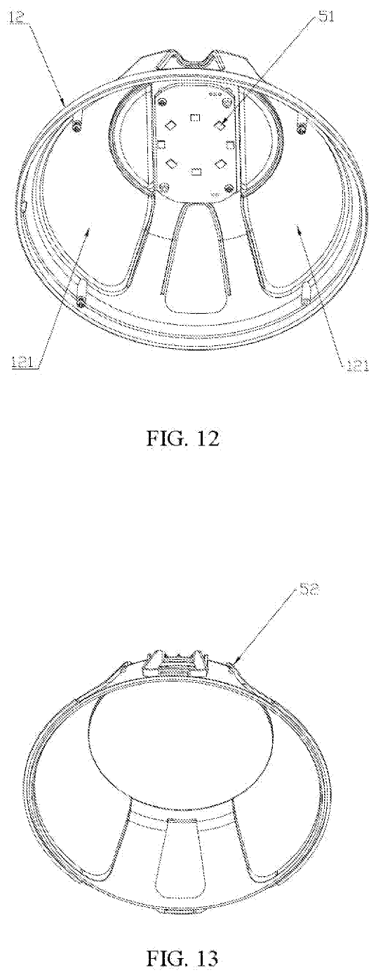

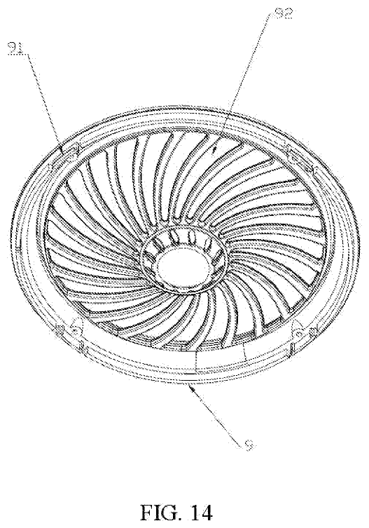

As shown in FIG. 1 to FIG. 14, a mosquito-killing lamp includes a shell. The shell is provided with an installation cavity 111 and a mosquito storage cavity 21; the installation cavity 111 and the mosquito storage cavity 21 are cut through; the shell is equipped with a fan 3 inside the installation cavity 111; the fan 3 is provided on the shell through a fan frame 4; the shell is provided with an air inlet 121 for mosquitoes to fly into the installation cavity 111; the shell is provided with an air outlet communicating with the mosquito storage cavity 21; the air inlet 121, the installation cavity 111, the mosquito storage cavity 21, and the air outlet constitute an air duct; the shell is provided with a manual operation open-close mechanism located between the installation cavity 111 and the installation cavity 21; the manual operation open-close mechanism has a first position for an opened state and a second position for a closed state; mosquitoes can enter the mosquito storage cavity 21 from the air inlet 121 when the manual operation open-close mechanism is at the first position for the opened state, and mosquitoes can be prevented from flying from the mosquito storage cavity 21 to the installation cavity 111 when the manual operation open-close mechanism is at the second position for the closed state. The manual operation open-close mechanism includes a toggle 72 or a knob and a blade 7. The toggle 72 or knob is operated to drive the blade 7 to move; and the blade 7 moves to realize the first position for the opened state and the second position for the closed state.

In the present embodiment, the shell is provided with a mosquito-retaining seat 6 between the installation cavity 111 and the mosquito storage cavity 21. The mosquito-retaining seat 6 can be provided on the shell in a one-piece or split manner. The mosquito-retaining seat 6 is provided with a first through hole 61 that communicates the installation cavity 111 with the mosquito storage cavity 21. The blade 7 is rotatably arranged on the mosquito-retaining seat 6; an end surface of the blade 7 is adhered to or close to an end surface of the mosquito-retaining seat 6. The toggle 72 or knob is operated to drive the blade 7 to rotate. When the blade 7 rotates to close the first through hole 61, the mosquitoes can be prevented from flying into the installation cavity 111 from the mosquito storage cavity 21. When the blade 7 rotates to open the first through hole 61, the mosquitoes can enter the mosquito storage cavity 21 from the air inlet 121. Of course, the blade can also be provided on the mosquito-retaining seat in a swinging manner. The toggle or knob drives the blade to swing to close or open the first through hole.

In the present embodiment, the mosquito-retaining seat 6 is of a disk shape; several first through holes 61 are provided and are distributed at intervals in a circumferential direction of the mosquito-retaining seat 6. The quantity and positions of the first through holes 61 can be designed according to an actual need. The blade 7 is provided with a second through hole 71 adapting to the shape of the first through hole 61. The blade 7 rotates to realize mutual communication or misalignment between the second through hole 71 and the first through hole 61. Of course, the blade may not be provided with the second through hole, either. It is certainly because a small number of relatively large first through holes are formed in the mosquito-retaining seat, and the blade directly closes or opens the first through holes. The shape of the blade is designed according to the shapes, the positions, and the quantity of the first through holes. Of course, there is more than one blade. A plurality of blades can be placed on the same horizontal plane or stacked in an up-down manner.

In the present embodiment, the shell is provided with a microswitch 8 close to the blade 7. When the blade 7 rotates to a position where the second through hole 71 and the first through hole 61 communicate with each other. It can be fully communicating or partially communicating. In the fully communicating state, a passage for the mosquitoes to fly in is maximum, and the blade 7 can trigger a contact of the microswitch 8. Of course, the microswitch 8 can also be triggered by the toggle.

In the present embodiment, the blade 7 is of a disk shape. Several second through holes 71 are provided and are distributed at intervals in the circumferential direction of the blade. The blade 7 is arranged above the mosquito-retaining seat 6; the middle of the mosquito-retaining seat 6 extends upwards to form a rotating shaft 63; the blade 7 is rotatably arranged on the rotating shaft 63; the mosquito-retaining seat 6 is provided with a limiting structure for limiting the rotation of the blade 7; the blade 7 is fixedly or integrally provided with a toggle 72; and the toggle 72 extends out of the shell. Of course, the blade 7 can also be disposed below the mosquito-retaining seat 6.

In the present embodiment, the shell includes an upper shell 1 and a lower shell 2. The upper shell 1 and the lower shell 2 are connected; the installation cavity 111 is arranged on the upper shell 1, and the mosquito storage cavity 21 is arranged on the lower shell 2; the mosquito-retaining seat 6 is clamped between the upper shell 1 and the lower shell 2; and the mosquito-retaining seat 6 and the lower shell 2 are in plugging fit. The mosquito-retaining seat 6 is provided with an insertion slot 62, and the lower shell 2 is provided with an insertion block 22; and the insertion block 22 is inserted into the insertion slot 62 to realize connection between the lower shell 2 and the mosquito-retaining seat 6. Of course, the mosquito-retaining seat can also be provided on the upper shell, as long as it is located below the fan.

In the present embodiment, the limiting structure is a first limiting seat 64 and a second limiting seat 65 that are fixedly or integrally provided on the mosquito-retaining seat 6. The first limiting seat 64 and the second limiting seat 65 are respectively located on two sides of the toggle 72. The toggle 72 presses against the first limiting seat 64 and the second limiting seat 65 to realize rotation limitation to the blade 7. Of course, the limiting structure is also realized by using a limiting pillar that is guided by a limiting slot to slide.

In the present embodiment, the blade 7 is fixedly or integrally provided with a press block 73. The microswitch 8 is mounted at the lower end of the upper shell 1, and the press block 73 of the blade 7 can trigger the contact of the microswitch 8.

In the present embodiment, the upper shell 1 includes a middle frame 11 and an upper cover 12; the upper cover 12 covers the middle frame 11 and is connected with the middle frame 11; the middle frame 11 is connected with the lower shell 2; the connection manner is that the middle frame 11 and the lower shell 2 are screwed by means of a stop block 112 and a stop slot 23 to restrain their separation and also realize their connection, and this is also convenient for disassembling, assembling and cleaning. The air inlet 121 is formed in the upper cover 12; the mosquito inlet cavity 111 is disposed in the middle frame 11; the fan frame 4 is fixedly or integrally provided in the middle frame 11; the lower end of the middle frame 11 is provided with a placement cavity 113 for installing the microswitch 8. The upper cover 12 is fixedly provided with a mosquito-lured lamp 51 that is a printed circuit board (PCB) with a light-emitting diode (LED); the upper cover 12 is provided with a lampshade 52 covering the mosquito-lured lamp 51; a protective sleeve 9 is clamped between the middle frame 11 and the upper cover 12; the protective sleeve 9 and the upper cover 12 are fixedly connected by screws, and the lampshade 52 is clamped between the upper cover 12 and the protective sleeve 9; and the protective sleeve 9 and the middle frame 11 are connected in a manner of snap-in connection between a clamping block 91 and a clamping slot 114. The protective sleeve 9 is provided with a through port 92 for mosquitoes to fly into the mosquito inlet cavity 111; and the middle frame 11 is also provided with a USB charger head 53. Of course, the microswitch 8 can also be arranged on the mosquito-retaining seat.

In the present embodiment, the air outlet includes a first air outlet 241 formed in a side wall of the lower shell 2 and a second air outlet 242 formed in a bottom surface of the lower shell 2. The lower shell 2 is fixedly provided with an anti-mosquito net 10 located at the second air outlet 242.

The above embodiments are only preferred specific embodiments of the present disclosure, and usual changes and substitutions made by those skilled in the art within the scope of the technical solution of the present disclosure all fall within the protection scope of the present disclosure.

What is claimed is:

1. A mosquito-killing lamp, comprising a shell, wherein the shell is provided with an installation cavity and a mosquito storage cavity; the installation cavity and the mosquito storage cavity are cut through; the shell is equipped with a fan inside the installation cavity; the shell is provided with an air inlet for mosquitoes to fly into the installation cavity; the shell is provided with an air outlet communicating with the mosquito storage cavity; the air inlet, the installation cavity, the mosquito storage cavity, and the air outlet constitute an air duct; the shell is provided with a manual operation open-close mechanism located between the installation cavity and the installation cavity; the manual operation open-close mechanism has a first position for an opened state and a second position for a closed state; mosquitoes enter the mosquito storage cavity from the air inlet when the manual operation open-close mechanism is at the first position for the opened state, and mosquitoes are prevented from flying from the mosquito storage cavity to the installation cavity when the manual operation open-close mechanism is at the second position for the closed state; the manual operation open-close mechanism comprises a toggle or a knob and a blade; the toggle or knob is operated to drive the blade to move; and the blade moves to realize the first position for the opened state and the second position for the closed state.

2. The mosquito-killing lamp according to claim 1, wherein the shell is provided with a mosquito-retaining seat located between the installation cavity and the mosquito storage cavity; the mosquito-retaining seat is provided with a first through hole that communicates the installation cavity with the mosquito storage cavity; the blade is rotatably arranged on the mosquito-retaining seat; an end surface of the blade is adhered to or close to an end surface of the mosquito-retaining seat; the toggle or knob is operated to drive the blade to rotate; when the blade rotates to close the first through hole, the mosquitoes are prevented from flying into the installation cavity from the mosquito storage cavity; and when the blade rotates to open the first through hole, the mosquitoes enter the mosquito storage cavity from the air inlet.

3. The mosquito-killing lamp according to claim 2, wherein the blade is provided with a second through hole adapting to the shape of the first through hole; the blade rotates to realize mutual communication or misalignment between the second through hole and the first through hole.

4. The mosquito-killing lamp according to claim 3, wherein the shell is provided with a microswitch close to the blade; when the blade rotates to a position where the second through hole and the first through hole communicate with each other, the blade triggers a contact of the microswitch.

5. The mosquito-killing lamp according to claim 2, wherein the blade is of a disk shape; the blade is arranged above the mosquito-retaining seat; the middle of the mosquito-retaining seat extends upwards to form a rotating shaft; the blade is rotatably arranged on the rotating shaft; the mosquito-retaining seat is provided with a limiting structure for limiting the rotation of the blade; the blade is fixedly or integrally provided with a toggle; and the toggle extends out of the shell.

6. The mosquito-killing lamp according to claim 3, wherein the blade is of a disk shape; the blade is arranged above the mosquito-retaining seat; the middle of the mosquito-retaining seat extends upwards to form a rotating shaft; the blade is rotatably arranged on the rotating shaft; the mosquito-retaining seat is provided with a limiting structure for limiting the rotation of the blade; the blade is fixedly or integrally provided with a toggle; and the toggle extends out of the shell.

7. The mosquito-killing lamp according to claim 4, wherein the blade is of a disk shape; the blade is arranged above the mosquito-retaining seat; the middle of the mosquito-retaining seat extends upwards to form a rotating shaft; the blade is rotatably arranged on the rotating shaft; the mosquito-retaining seat is provided with a limiting structure for limiting the rotation of the blade; the blade is fixedly or integrally provided with a toggle; and the toggle extends out of the shell.

8. The mosquito-killing lamp according to claim 4, wherein the shell comprises an upper shell and a lower shell; the upper shell and the lower shell are connected; the installation cavity is arranged on the upper shell, and the mosquito storage cavity is arranged on the lower shell; the mosquito-retaining seat is clamped between the upper shell and the lower shell; and the mosquito-retaining seat and the lower shell are in plugging fit.

9. The mosquito-killing lamp according to claim 5, wherein the limiting structure is a first limiting seat and a second limiting seat that are fixedly or integrally provided on the mosquito-retaining seat; the first limiting seat and the second limiting seat are respectively located on two sides of the toggle; and the toggle presses against the first limiting seat and the second limiting seat to realize rotation limitation to the blade.

10. The mosquito-killing lamp according to claim 6, wherein the blade is provided with a press block; the microswitch is mounted at the lower end of the upper shell; and the press block of the blade triggers the contact of the microswitch.

11. The mosquito-killing lamp according to claim 6, wherein the upper shell comprises a middle frame and an upper cover; the upper cover covers the middle frame and is connected with the middle frame; the middle frame is connected with the lower shell; the air inlet is formed in the upper cover; the installation cavity is disposed in the middle frame; the upper cover is provided with a mosquito-lured lamp; the upper cover is provided with a lampshade covering the mosquito-lured lamp; a protective sleeve is clamped between the middle frame and the upper cover; and the protective sleeve is provided with a through port for mosquitoes to fly into the installation cavity.

12. The mosquito-killing lamp according to claim 8, wherein the upper shell comprises a middle frame and an upper cover; the upper cover covers the middle frame and is connected with the middle frame; the middle frame is connected with the lower shell; the air inlet is formed in the upper cover; the installation cavity is disposed in the middle frame; the upper cover is provided with a mosquito-lured lamp; the upper cover is provided with a lampshade covering the mosquito-lured lamp; a protective sleeve is clamped between the middle frame and the upper cover; and the protective sleeve is provided with a through port for mosquitoes to fly into the installation cavity.

13. The mosquito-killing lamp according to claim 6, wherein the air outlet comprises a first air outlet formed in a side wall of the lower shell and a second air outlet formed in a bottom surface of the lower shell; and the lower shell is provided with an anti-mosquito net located at the second air outlet.

14. The mosquito-killing lamp according to claim 8, wherein the air outlet comprises a first air outlet formed in a side wall of the lower shell and a second air outlet formed in a bottom surface of the lower shell; and the lower shell is provided with an anti-mosquito net located at the second air outlet.
